(19) United States
(12) Patent Application Publication
(10) Pub. No.: US 2005/0262988 A1
(43) Pub. Date: Dec. 1, 2005

(54) Strobe tuner

(76) Inventor: Victor Yurkovsky, Woodstock, NY (US)

Correspondence Address: FROMMER LAWRENCE & HAUG, 745 FIFTH AVENUE- 10TH FL., NEW YORK, NY, 10151, US

(21) Appl. No.: 10/858,312

(22) Filed: Jun. 1, 2004

(51) Int. Cl. G10G 7/02

(52) U.S. Cl. 84/455

(57) ABSTRACT

A hand-held tuning device for stringed musical instruments consisting of two stroboscopic light sources of different colors (such as LEDs or semiconductor lasers) mounted on a guitar pick-shaped board complete with a miniature battery and the circuitry necessary to drive the light sources at standard frequencies of strings. A single pushbutton activates the device causing the two colored light sources to flash one at a time at the desired frequency while simultaneously engaging a miniature piezo buzzer that emits a tone of the same frequency. The device operates while the button is pressed; each subsequent press advances the frequency to that of the next string to be tuned. The instrument is tuned by plucking a string with the pick tip while directly observing the string for moving reflections of the two colored light sources, and subsequently adjusting the tuning until the two colored reflections are stationary relative to each other.

### FIELD OF THE INVENTION

The present invention is directed to a method and apparatus for tuning a musical instrument. More specifically, the present invention is directed to a strobe tuner that enables a person to tune a string type musical instrument.

### BACKGROUND OF THE INVENTION

Conventional tuning devices can be divided into two broad categories: devices that use various external means to analyze and display the tuning error of a string, and devices that, through passive stroboscopic illumination of the string, allow the musician to directly observe the tuning error.

Devices in the first category, which include almost all commonly, used tuners today, couple electrically or acoustically to the instrument using the instrument's existing pickups, a microphone, or another transducer. The electrical signal corresponding to the frequency of the string is subsequently analyzed and compared to a reference frequency through various means. Some form of an indicator is then utilized to display the difference between the string frequency and the reference frequency, allowing the user to adjust the string frequency to match the reference frequency.

All devices in this category require the musician to unplug the instrument and plug in the tuner, or in case of acoustic coupling, require the surrounding environment to be relatively quiet to avoid interfering with the tuning process. The coupling to the instrument is a major shortcoming of this category.

Most low-cost devices in this category use electronic circuits to analyze the frequency differential and light up a single indicator light to signify that the string is ‘in-tune’. The drawback of these devices is that either a fairly wide range of frequencies is acceptable to satisfy the match state, resulting in poor accuracy, or the device is frustratingly hard to use due to a very narrow acceptable range, causing the musician to repeatedly tune up and down ‘chasing’ the elusive ‘in-tune’ position. Some mid-range devices use a plurality of lights or a needle indicator to communicate the relative frequency difference to the musician.

In the 1970's, ‘strobe tuners’ became popular with musicians due to exceptional accuracy. These devices utilized a wheel with black and white markings rotating at a constant velocity while illuminated by a strobe light controlled by the frequency of a string being tuned. Capitalizing on the well known property of the human perceptual system allows us to easily discern relative motion, a strobe tuner allows the musician to adjust the string frequency until the strobe light coupled to the string frequency and the markings on the rotating disk are in synchronization, and the apparent rotating motion of the markings on the disk slows down and stops. These devices fell out of favor due to their high cost, bulk and weight, and the need for careful calibration due to the presence of moving parts.

Examples of this type of device include U.S. Pat. No. 3,861,266 (Whitaker, Jan. 21, 1975), U.S. Pat. No. 3,952,625 (Peterson, Feb. 18, 1975), U.S. Pat. No. 5,016,515 (Scott, May 21, 1991), U.S. Pat. No. 4,252,048 (Pogoda, Feb. 24, 1981).

Devices in the second category directly illuminate the string with one or more flashing light sources tuned to the desired frequency, and allow for the tuning of the instrument until the strobe illuminates the vibrating string in the same exact position.

The devices in the second category have not achieved commercial success partly because the existing sources of illumination capable of rapid switching were simply too dim to sufficiently illuminate the strings in common lighting conditions and due to the bulk of the devices capable of providing stroboscopic illumination.

Examples of devices belonging to the second category include the following U.S. patents:
U.S. Pat. No. 3,385,153 (England, May 28, 1968) requires a special guitar with frets spaced in such a way that a television screen illumination is used as the source of the stroboscopic light;
U.S. Pat. No. 4,061,071 (Cameron, Dec. 6, 1977) describes a single-light source stroboscopic tuner device that encloses the strings while providing a source of illumination from behind the string. The apparent vibration of the shadow of the string is observed through a slot cut into the enclosure above the string;
U.S. Pat. No. 4,335,642, issued to Pogoda on Jun. 22, 1982, describes a device that uses a monochromatic strobe light source with filter for observation;
U.S. Pat. No. 4,365,537 (Pogoda, Dec. 28, 1982) discloses a hand-held stroboscopic device with a slot containing optical magnification machinery for direct observation of a string being tuned; and
U.S. Pat. No. 5,959,229, issued to Walley on Sep. 28, 1999 discloses a plurality of stroboscopic light sources mounted behind the string aimed at the user's eyes, allowing the user to observe the shadow of the vibrating string against the light source.

### SUMMARY OF THE INVENTION

In view of the above-described disadvantages of conventional tuners, the present invention proposes a simpler method for tuning string instruments and a device to accomplish the same.

In an embodiment of the present invention, method for tuning a stringed musical instrument is provided. The method includes the steps of providing a number of sources of stroboscopic light of different color, generating a number of out-of-phase electrical impulses at a frequency equal to the required frequency of the string, using the generated electrical signals to drive the stroboscopic light sources to illuminate one string of a musical instrument, and observing the relative movement of the colored reflections while adjusting the tension of the string until the colored reflections are stationary in relation to each other.

In an embodiment of the present invention, the light sources are of distinctly different color to enhance the apparent motion of the reflections.

In an embodiment of the present invention, at least one of the light sources is a semiconductor laser.

In an embodiment of the present invention, the light sources are ‘ultra-bright’ light emitting diodes (LEDs).

In an embodiment of the present invention, in order to ‘freeze’ the position of the string in time, the duty cycle of the pulses used to drive the light sources is ⅛ of the string frequency or shorter.

In an embodiment of the present invention a piezo buzzer device is simultaneously driven by the same frequency signal to provide an auditory reference to the user, further simplifying the task at hand.

In an embodiment of the present invention, a miniature dynamic speaker is simultaneously driven by the same frequency signal to provide a direct auditory reference to the user, and to simultaneously emit a matching electromagnetic frequency that can be received by a common electric guitar pickup and subsequently amplified with the existing amplification equipment, for the purpose of providing a reference tuning frequency for other musicians to tune their instruments to.

In an embodiment of the present invention, a switch is provided to activate the device and operate it while it is pressed. Preferably, each press of the switch changes the reference frequency, allowing the user to sequentially tune all instrument strings.

In an embodiment of the present invention, a second switch is provided to allow the user to fine-tune the entire set of reference frequencies to another instrument by illuminating a ‘known-good’ string and allowing the user to fine-tune the stroboscopic frequency by repeatedly pressing such switch until it matches the known-good frequency.

In an embodiment of the present invention, a single low-cost micro controller chip is used to drive the light and sound sources of the device as well as monitor the switches.

In an embodiment of the present invention, such a micro controller is capable of a low-power ‘sleep’ mode, allowing the device to be on continuously and requiring no power switch.

In an embodiment of the present invention, the entire device is placed on a printed circuit board matching the size and the shape of a common guitar pick, utilizing surface mount components and technologies and small ‘coin’ battery cells.

In an embodiment of the present invention, the main operating switch is push-button in nature and is centrally located on the pick-shaped device, such that grasping the device firmly in the manner of a guitar pick activates the strobes and the audio signal.

In an embodiment of the present invention, the strobe light sources are oriented in such a way that while plucking a string with the pick-shaped device, the string is illuminated by the said strobe lights.

### BREIF DESCRIPTION OF THE DRAWINGS

The following Detailed Description, given to describe the invention by way of example, but not intended to limit the invention to specific embodiments described, may be understood in conjunction with the accompanying Figures, incorporated herein by reference, in which:

FIGS. 1(a) and 1(b) are diagrams of strobe tuners in accordance with an embodiment of the invention;

FIG. 2 depicts a block diagram in accordance with an embodiment of the invention; and

FIG. 3 is a flow diagram in accordance with an embodiment of the invention.

### DETAILED DESCRIPTION OF THE INVENTION

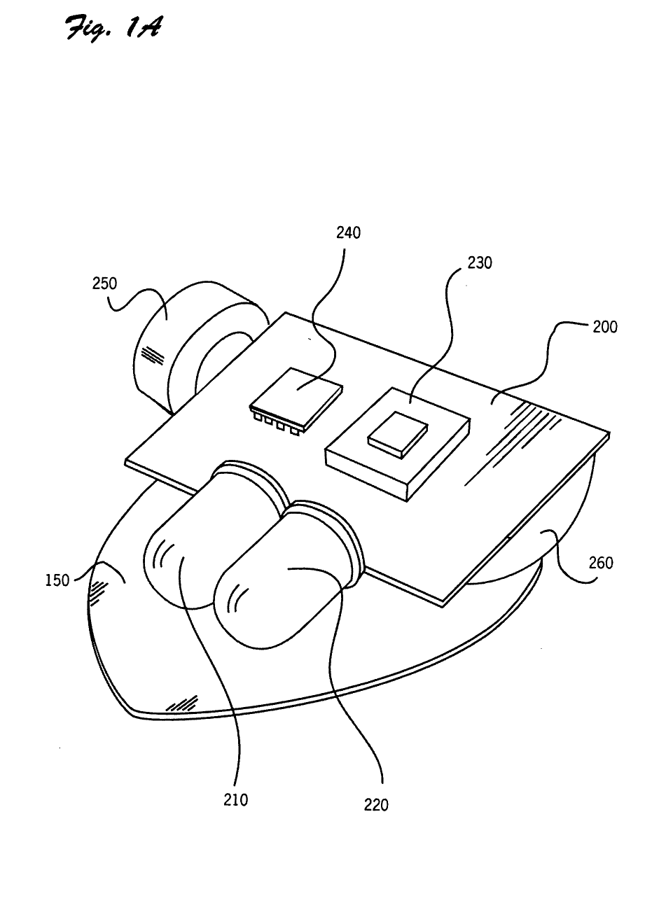

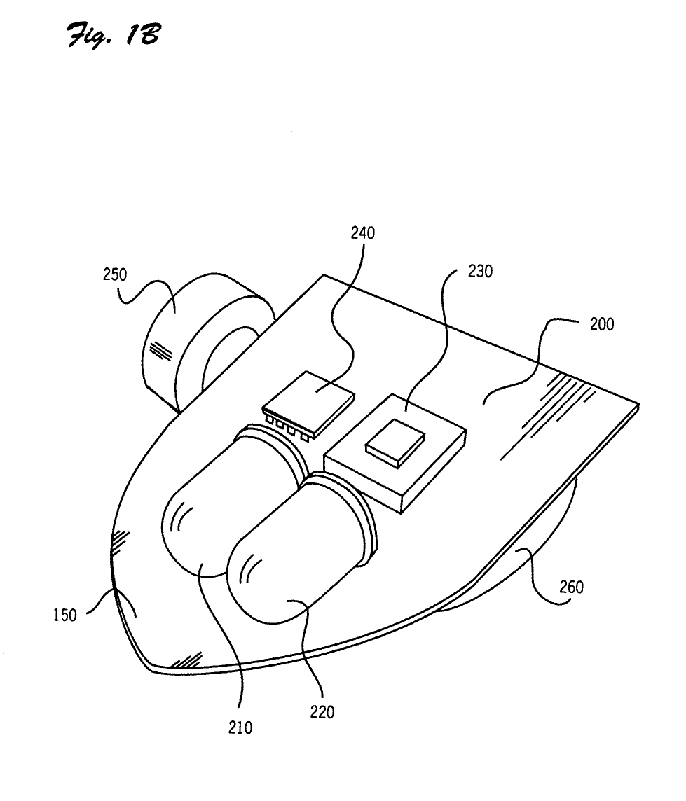

The present invention is directed to a strobe tuner suitable for tuning string instruments. As shown in FIG. 1(a), the strobe tuner may be constructed such that it may be affixed to a guitar pick. Alternatively, the guitar pick may be incorporated into the strobe tuner, where the pick itself is an integral part of the printed circuit board, as shown in FIG. 1(b)

Although FIGS. 1(a) and 1(b) depicts a strobe tuner affixed to a printed circuit board the size of a guitar pick, it may be possible to place the strobe tuner on any item that is easily portable. For instance, the strobe tuner may be incorporated into a key chain, a pen, and a relatively thin piece of plastic shaped like a credit card, etc.

As shown in FIG. 1(a), the strobe tuner 200 is placed on a guitar pick 100. Such a configuration is not only aesthetically pleasing, but also serves a practical function. By placing the tuner 200 on pick 100, the strobe tuner is portable. Light emitting sources (LESs) 210 and 220 are placed on the narrow end of the pick so that when a string is played by the pick, LESs 210 and 220 emit light on to the vibrating string. Preferably, LESs 210 and 220 are of different colors so that the lights reflected off the vibrating string are easily discernable. FIG. 1(b) differs from FIG. 1(a) in that the guitar pick 150 itself is a printed circuit board and the components of the strobe tuner may be surface mounted onto the pick 150. Preferable, the guitar pick of FIG. 1(b) has a thickness of approximately 1/32 of an inch. LESs 210 and 220 are also surface mounted on the narrower end of pick 150 and bent over to point forward.

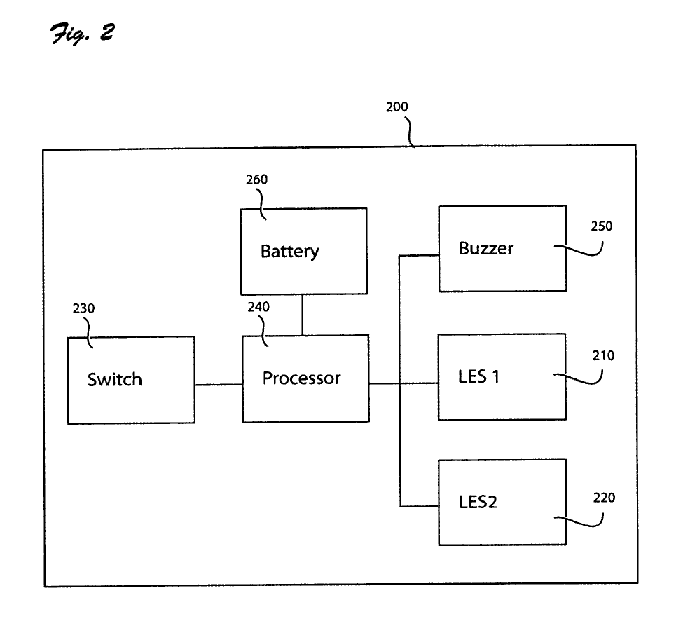

FIG. 2 is a block diagram of a circuit that may be used in an embodiment of the present invention. As shown in FIG. 2, a battery 260 powers the components of strobe tuner 200. A processor 240 may be used to control strobe tuner 200. Processor 240 may store a number of frequencies that correspond to the different frequencies produced by the strings of the musical instrument. For instance, if the strobe tuner is adapted to be able to tune a guitar, then processor 240 may store six frequencies. A user using the strobe tuner 200 may cycle through the frequencies by pressing and releasing a main switch 230. The frequencies or string tones may change sequentially from a low E tone to a high E tone. Main switch 230 may be a push button switch.

In an embodiment of the invention, the frequencies are generated using an internal clock built into the processor 240. Although, the internal clock of the processor 240 is used, other source may be utilized to generate the frequencies. Such sources include, but are not limited to, crystal oscillators, ceramic resonators, resistor/capacitor (RC) oscillators, etc.

When main switch 230 is pressed, processor 240 sends a sequence of pulses designed to uniquely identify the frequency being emitted to the LESs 210 and 220. The user can cycle through the frequencies by repeatedly pressing the switch until the desired frequency is emitted.

When main switch 230 is pressed, processor 240 may provide a signal to buzzer 250 such as a miniature speaker. Buzzer 250 emits a sound corresponding to the frequency being used to tune the guitar. When main switch 230 is released, the processor 240 may enter a low power mode until main switch 230 is pressed again. While in a low power mode, processor 240 stores the frequency that was previously used to tune the guitar. As such, when main switch 230 is pressed again, the processor recalls the previously used frequency and selects a different frequency to tune a different string. If the user does not hear the appropriate frequency from buzzer 250 for tuning a particular string, the user may cycle through the frequencies until he/she reaches the appropriate frequency. After a period of inactivity processor 240 may reset the index of the next frequency to be generated to prepare for the next tuning session and enter a low power mode.

LES 210 and LES 220 may emit light at a frequency equal to the frequency being used to tune a particular string. Processor 240 outputs two out of phase electrical impulses at the tuning frequency in order to drive LESs 210 and 220. As with the audible frequency of buzzer 250, the visual frequency of LESs 210 and 220 are changed by pressing main switch 230. Light emitted from LES 210 may be out of phase from the light emitted by LES 220. Preferably, the duty cycle of the pulses used to drive LES 210 and 220 are ⅛ of the string frequency or shorter. By having such a short duty cycle, it may be possible to “freeze” the visual position of the string in time. By freezing the visual position of the string at each cycle of the frequency, it may be easier to tune the musical instrument because the apparent motion of the string as it is illuminated by stroboscopic lights may be easier to discern.

Any appropriate light sources may be used as LESs 210 and 220. For instance, it may be possible to use a semiconductor laser such as, but not limited to, a GaAs (Gallium Arsenic) semiconductor laser. Such semiconductor laser may be used without a collimation lens so that a wide angle of illumination may be provided. Alternatively, a specially designed collimation lens may be provided so that angle of illumination is preferably 15 to 30 degrees in at least one dimension. Alternatively, “ultra-bright” LEDs may be used to tune the guitar. Preferably, the ultra-bright LEDS may have a brightness specification of approximately 5000 mcds (millicandelas) or more, although it is possible to use LEDs with a different brightness specification. The spread angle of the LEDs is approximately 15 to 30 degrees although it may be possible to use LEDs with other spread angles. It should be noted that LESs 210 and 220 may be two semiconductor lasers, two LEDs, or a combination of the two.

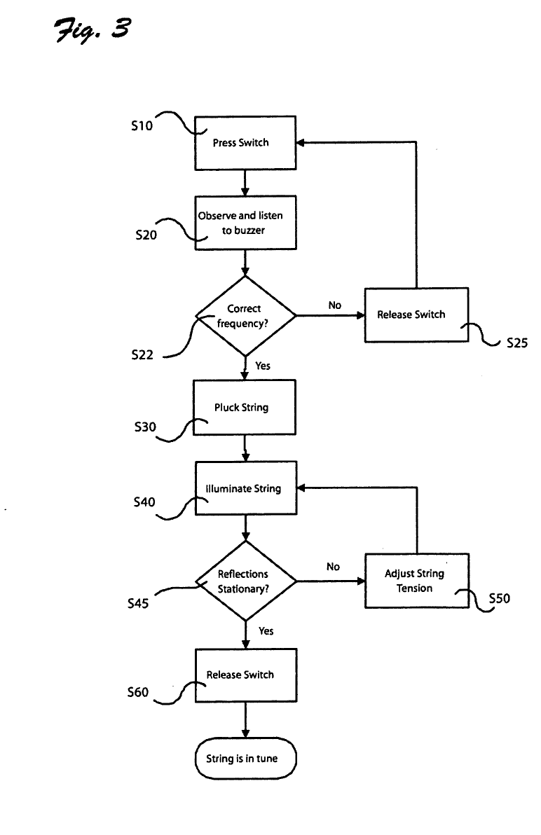

FIG. 3 is a flow diagram depicting a method of tuning a musical instrument in accordance with a present embodiment of the invention. In step S10, a user presses the switch on the tuning device. In step S20 the user may determine the frequency at which the device is operating by listening to the tone produced by the buzzer, and/or visually observing the distinctive flashing pattern emitted by the stroboscopic lights immediately upon activation. If the frequency produced by the device does not match the frequency of the desired string in step S22, the user releases the switch in step S25 and returns to step S10, advancing the device to the next pre-programmed frequency. The process is repeated until the desired frequency is selected.

Once the desired operating frequency is selected, the user plucks the string with the pick-shaped tip of the device in step S30 and illuminates the string with the two LESs in step S40 in such a way that the reflections of the LESs on the string are highly visible. In step S45, the reflected lights are observed. If the reflections of the two colored lights are not stationary in relation to each other, then the user proceeds to step S50 where the tension of the string is adjusted, and further to step S40. However, after step S45, if the lights are stationary in relation to each other, then the string is tuned to the desired frequency. The user then releases the switch in step S60, and if necessary, the process is repeated for the next string from step S10.

Having thus described in detail preferred embodiments of the present invention, it is to be understood that the invention defined by the appended claims is not to be limited to particular details set forth in the above description. Many apparent variations thereof are possible without departing from the spirit or scope of the present invention.

For instance, any device capable of emitting sound may be used instead of the buzzer to output an audible signal.

Alternatively, a visual readout may be provided to indicate which frequency processor 240 has currently selected. Such readout can be in the form of an 7 or 8 segment LED display, or a number of LEDs may be used, with each LED corresponding to a different frequency. Additionally, LEDs or the LESs may flash once with a pattern to indicate which tone is being emitted (for noisy environments). Switching to low E may blink both LESs once; switching to D may blink one LES once and B may blink the other.

Further, it may be possible to fine-tune the entire set of frequencies using a second switch or calibration switch. In such a case, a string known to be in tune is illuminated, and the second switch repeatedly pressed until the stroboscopic frequency matches the known good frequency as indicated by the lack of apparent motion of the stroboscopic light reflected off the string.

Using the calibration switch, many modes of calibration may be possible. In the first mode, pressing and holding the calibration switch puts the device into micro-tuning mode for fine-tuning to another instrument. While holding the calibration switch, every press of the main switch adjusts the entire set of stored frequencies up a small amount by using a adjusting the frequency generator (wrapping around to a lower frequency eventually). Yet another mode allows for changing the tuning in increments of an entire semitone. Pressing and holding the main switch activate the second mode. While holding the main switch, the calibration switch tunes down by a semitone for every press (wrapping around to a higher frequency eventually). Yet another mode allows the user to select a particular tuning (a group of string frequencies) from a set of possible tunings. Yet another mode allows for a particular kind of temperaments, or ratios between string frequencies.

Additionally, although the present invention is described as having two light emitting sources, it may be possible to utilize more than two light emitting sources to further enhance the apparent motion of the reflections of the light sources.

In addition, the present invention may be adapted to tune traditionally hard-to-tune instruments with many strings, such as pianos and harps. Other switches may be added to change octaves or otherwise accommodate such instruments.

Furthermore, the strobe tuner may be enclosed in a protective casing.

1. A method for tuning a stringed musical instrument comprising the steps of:
providing a plurality of stroboscopic light sources, each light source having a different color;
generating a plurality of out-of-phase electrical impulses at a frequency equal to the required frequency of the string;
driving said plurality of stroboscopic light sources using the generated electrical signals to illuminate one string of a musical instrument; and
observing the relative movement of lights reflecting off of said string while adjusting a tension of said string until the reflected lights are stationary in relation to each other.

2. The method of claim 1, wherein at least one of said plurality of stroboscopic light sources is a semiconductor laser.

3. The method of claim 1, wherein at least one of said plurality of stroboscopic light sources is a light emitting diode.

4. The method of claim 1, wherein the duty cycle of the electrical signals is less than or approximately equal to ⅛ of the required frequency of the string.

5. The method of claim 1, wherein a piezo electric buzzer is driven at the required frequency of the string.

6. The method of claim 1, wherein an electromagnetic speaker is driven at the required frequency of the string, simultaneously providing a tone source capable of being received by commonly-used guitar pick-ups and amplified using commonly-used equipment

7. The method of claim 1, further comprising the step of selecting a desired frequency from a number of frequencies by manipulating a switch.

8. A strobe tuner comprising:
a switch that activates the strobe tuner and cycles through a number of frequencies;
a first stroboscopic light source that emits light at a frequency approximately equal to a required frequency of a string;
a second stroboscopic light source that emits light at the frequency approximately equal to the required frequency of said string; and
a processor that generates a first electrical signal and a second electrical signal to drive said first stroboscopic light source and said second stroboscopic light source out of phase respectively,
wherein said first stroboscopic light source and said second stroboscopic light source are different colors.

9. The strobe tuner of claim 8, wherein said first stroboscopic light source is a semiconductor laser.

10. The strobe tuner of claim 8, wherein said first stroboscopic light source is a light emitting diode.

11. The strobe tuner of claim 8, wherein said first stroboscopic light source and said second stroboscopic light are semiconductor lasers.

12. The strobe tuner of claim 8, wherein said first stroboscopic light source and said second stroboscopic light are light emitting diodes.

13. The strobe tuner of claim 8, wherein said first stroboscopic light source is semiconductor laser and said second stroboscopic light is a light emitting diode.

14. The strobe tuner of claim 8, wherein the duty cycle of said first electrical signal and said second electrical signal is less than or approximately equal to ⅛ of the required frequency of the string.

15. The strobe tuner of claim 8, further comprising a piezo electric buzzer driven at the required frequency of the string.

16. The strobe tuner of claim 8, further comprising an electromagnetic speaker driven at the required frequency of the string, simultaneously providing a tone source capable of being received by commonly-used guitar pick-ups and amplified using commonly-used equipment.

17. The strobe tuner of claim 8, wherein a desired frequency from a number of frequencies is selected by repeatedly pressing said switch.

18. The strobe tuner of claim 8, further comprising a second switch to calibrate said number of frequencies to a reference frequency source.

19. The strobe tuner of claim 8, wherein said strobe tuner is disposed on a printed circuit board matching the size and shape of a guitar pick.

20. The strobe tuner of claim 8, wherein said switch is a push button switch.

21. The strobe tuner of claim 8, wherein said processor remembers a frequency previously used so that when a user activates said switch a new frequency is used to tune a new string.

22. The strobe tuner of claim 8, wherein said processor resets the remembered frequency after a period of non-use so that when a user starts a new tuning session, the tuner is guaranteed to be in a known frequency.

23. The strobe tuner of claim 8 further comprising a visual readout means for indicating a selected frequency for tuning said string.

24. The strobe tuner of claim 8 further comprising a calibration switch for calibrating said number of frequencies.

25. The strobe tuner of claim 8, wherein said strobe tuner is enclosed in a protective casing.
